(19) United States
(12) Patent Application Publication
(10) Pub. No.: US 2026/0187852 A1
(43) Pub. Date: Jul. 2, 2026

(54) MESH DECODING DEVICE, MESH ENCODING DEVICE, MESH DECODING METHOD, AND NON-TRANSITORY COMPUTER-READABLE MEDIUM

(71) Applicant: KDDI CORPORATION, Tokyo (JP)

(72) Inventors: Koki KISHIMOTO, Fujimino-shi (JP); Kei KAWAMURA, Fujimino-shi (JP)

(73) Assignee: KDDI CORPORATION, Tokyo (JP)

(21) Appl. No.: 19/550,858

(22) Filed: Feb. 26, 2026

Related U.S. Application Data
(63) Continuation of application No. PCT/JP2024/007926, filed on Mar. 3, 2024.

(30) Foreign Application Priority Data
Oct. 5, 2023 (JP) 2023-173914

(51) Int. Cl. G06T 9/00; G06T 9/20

(52) U.S. Cl. CPC G06T 9/001; G06T 9/20

(57) ABSTRACT

A mesh decoding device 200 according to the present invention includes: an atlas data decoding unit 207 decodes an atlas bit stream to generate and output control information; a base mesh decoding unit 202 decodes the control information and a base mesh bit stream to generate and output a base mesh; a subdivision unit 203 outputs a subdivision mesh and a subdivision vertex normal line using the control information and the base mesh as inputs; a mesh decoding unit 204 generates a decoded mesh using the control information, a displacement, the subdivision mesh, and the subdivision vertex normal line as inputs; and a boundary correction unit 208 corrects a sub-mesh boundary for the decoded mesh and output a boundary corrected decoded mesh.

### CROSS-REFERENCE TO RELATED APPLICATIONS

The present application is a continuation of PCT Application No. PCT/JP2024/007926, filed on March 3, 2024, which claims the benefit of Japanese patent application No. 2023-173914 filed on October 5, 2023, the entire contents of each application being incorporated herein by reference in its entirety.

### TECHNICAL FIELD

The present invention relates to a mesh decoding device, a mesh encoding device, a mesh decoding method, and a non-transitory computer-readable medium.

### BACKGROUND ART

In Non Patent Literature 1 (Khaled Mammou, Jungsun Kim, Alexis Tourapis, Dimitri Podborski, Krasimir Kolarov, “[V-CG] Apple's Dynamic Mesh Coding CfP Response,” ISO/IEC JTC 1/SC 29/WG 7 m5928, April 2022), a mesh is decoded by being divided into a base mesh representing rough information and a displacement representing detailed information, and such a displacement is decoded by a video codec.

### SUMMARY OF THE INVENTION

However, in Non Patent Literature 1, if intra-frame mesh data is encoded in units of sub-mesh, a hole may be open at sub-mesh boundary parts, and subjective performance may be degraded.

In order to prevent a hole from being open in a decoded mesh, it is necessary to correct the sub-mesh boundary at the time of decoding. In order to perform such correction, it is necessary to embed sub-mesh boundary information in a bit stream. However, there is a problem that the data amount increases if the sub-mesh boundary information is transmitted as it is. Therefore, the present invention has been made in view of the above-described problem, and an object of thereof is to provide a mesh decoding device, a mesh decoding method, and a program capable of efficiently encoding boundary information using redundancy included in indexes of the boundary information.

The first aspect of the present invention is summarized as a mesh decoding device including: an atlas data decoding unit configured to decode an atlas bit stream to generate and output control information; a base mesh decoding unit configured to decode the control information and a base mesh bit stream to generate and output a base mesh; a subdivision unit configured to output a subdivision mesh and a subdivision vertex normal line using the control information and the base mesh as inputs; a mesh decoding unit configured to generate a decoded mesh using the control information, a displacement, the subdivision mesh, and the subdivision vertex normal line as inputs; and a boundary correction unit configured to correct a sub-mesh boundary for the decoded mesh and output a boundary corrected decoded mesh.

The second aspect of the present invention is summarized as a mesh decoding method, including: decoding an atlas bit stream to generate and output control information; generating and outputting a base mesh using the control information and a base mesh bit stream as inputs; outputting a subdivision mesh and a subdivision vertex normal line using the control information and the base mesh as inputs; generating a decoded mesh using the control information, a displacement, the subdivision mesh, and the subdivision vertex normal line as inputs; and correcting a sub-mesh boundary for the decoded mesh and outputting a boundary corrected decoded mesh.

The third aspect of the present invention is summarized as a non-transitory computer-readable medium having stored thereon a program that causes a computer to function as a mesh decoding device, wherein the mesh decoding device includes: an atlas data decoding unit configured to decode an atlas bit stream to generate and output control information; a base mesh decoding unit configured to generate and output a base mesh using the control information and a base mesh bit stream as inputs; a subdivision unit configured to output a subdivision mesh and a subdivision vertex normal line using the control information and the base mesh as inputs; a mesh decoding unit configured to generate a decoded mesh using the control information, a displacement, the subdivision mesh, and the subdivision vertex normal line as inputs; and a boundary correction unit configured to correct a sub-mesh boundary for the decoded mesh and output a boundary corrected decoded mesh.

According to the present invention, it is possible to provide a mesh decoding device, a mesh decoding method, and a program capable of efficiently encoding boundary information using redundancy included in indexes of the boundary information.

### BRIEF DESCRIPTION OF THE DRAWINGS

FIG. 1 is a diagram illustrating an example of a configuration of a mesh processing system 1 according to an embodiment.

FIG. 2 is a diagram illustrating an example of functional blocks of a mesh decoding device 200 according to an embodiment.

FIG. 3 is a diagram illustrating an example of a syntax configuration of AVE according to a first embodiment.

FIG. 4 is a diagram illustrating an example of sub-meshes decoded by a base mesh decoding unit 202.

FIG. 5 is a diagram for explaining an example of indexes of boundary pairs according to the first embodiment.

FIG. 6 is a diagram illustrating an example of a syntax configuration of the AVE according to a second modification.

FIG. 7 is a diagram for explaining an example of indexes of boundary pairs according to the second modification.

FIG. 8 is a diagram illustrating an example of a syntax configuration of the AVE according to a third modification.

FIG. 9 is a diagram illustrating an example of a base mesh.

FIG. 10 is a diagram illustrating an example of subdivision meshes.

FIG. 11 is a diagram schematically illustrating a method of boundary correction.

### DETAILED DESCRIPTION

Hereinafter, embodiments of the present invention will be described with reference to the drawings. Note that components in the following embodiments can be replaced with existing components or the like as appropriate, and various variations including combinations with other existing components are possible. Therefore, the following description of the embodiments does not limit the contents of the invention described in the claims.

### First Embodiment

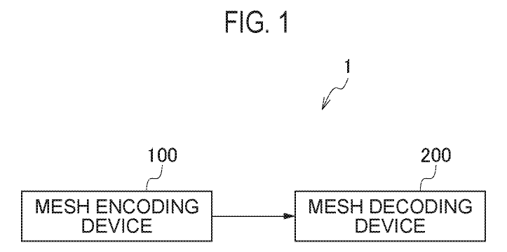

Hereinafter, a mesh processing system 1 according to the present embodiment will be described with reference to FIGS. 1 to 12.

FIG. 1 is a diagram illustrating an example of a configuration of the mesh processing system 1 according to the present embodiment. As illustrated in FIG. 1, the mesh processing system 1 includes a mesh encoding device 100 and a mesh decoding device 200.

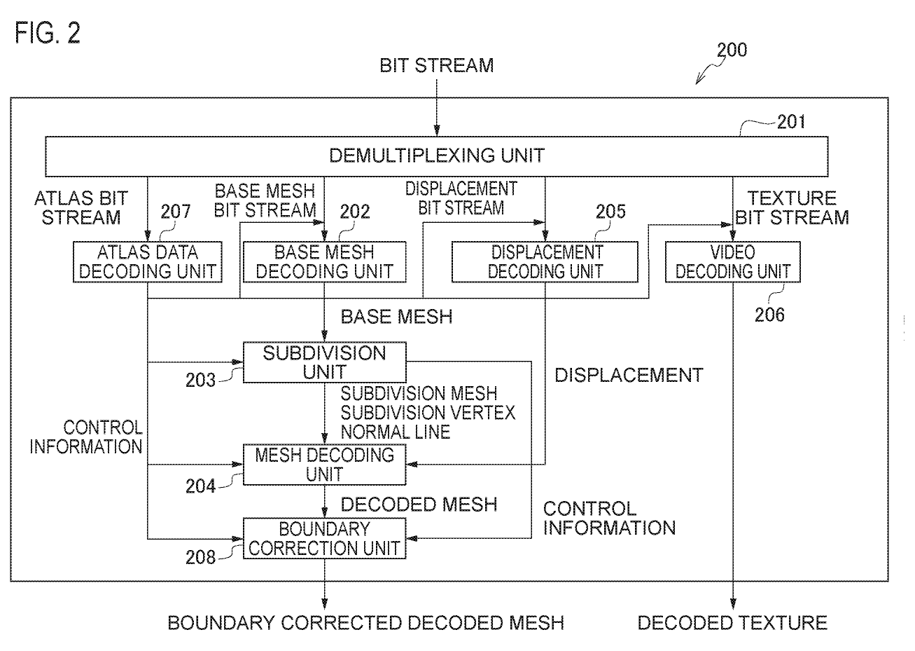

FIG. 2 is a diagram illustrating an example of functional blocks of the mesh decoding device 200 according to the present embodiment.

As illustrated in FIG. 2, the mesh decoding device 200 includes a demultiplexing unit 201, a base mesh decoding unit 202, a subdivision unit 203, a mesh decoding unit 204, a displacement decoding unit 205, a video decoding unit 206, an atlas data decoding unit 207, and a boundary correction unit 208.

The demultiplexing unit 201 is configured to separate a multiplexed bit stream into an atlas bit stream, a sub-mesh bit stream, a displacement bit stream, a texture bit stream, and an atlas bit stream.

The base mesh decoding unit 202 is configured to decode a base mesh bit stream on the basis of control information and generate and output the control information and the base mesh.

The subdivision unit 203 is configured to generate and output subdivision vertices and connection information thereof from the base mesh decoded by the base mesh decoding unit 202 by a subdivision method indicated by the control information.

Here, the base sub-mesh, the added subdivision vertex, and the connection information thereof are collectively referred to as a “subdivision mesh”.

The mesh decoding unit 204 is configured to generate and output a decoded mesh using the control information, the subdivision mesh, the subdivision vertex normal line, and the displacement.

The displacement decoding unit 205 is configured to decode the displacement bit stream on the basis of the control information to generate and output the displacement.

The video decoding unit 206 is configured to decode and output texture through video codec.

The atlas data decoding unit 207 is configured to decode an atlas bit stream and output the control information.

The boundary correction unit 208 is configured to correct the sub-mesh boundaries for the input decoded mesh and output a boundary corrected decoded mesh.

### Atlas Data Decoding Unit 207

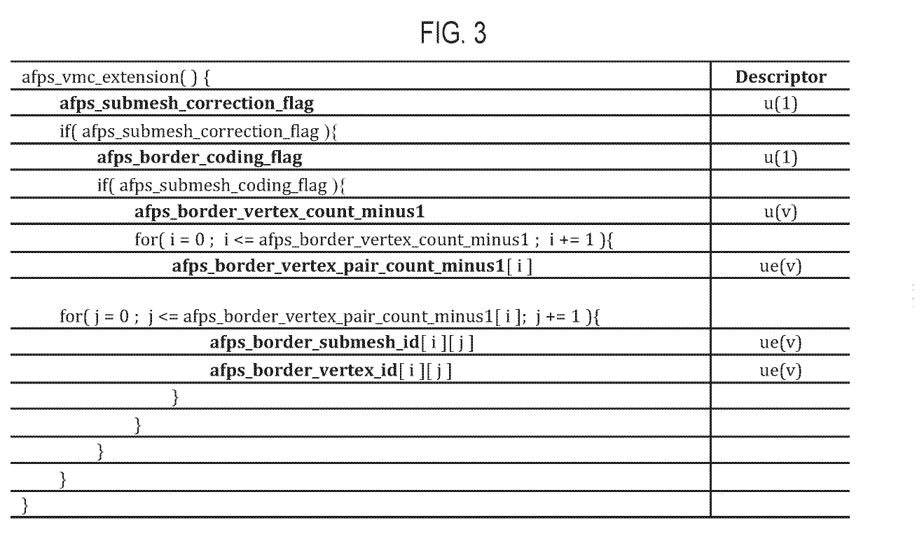

Hereinafter, the control information decoded by the atlas data decoding unit 207 will be described with reference to FIGS. 3 to 8.

First, the atlas bit stream may include afps vmc extension (AVE), which is a collection of atlas control information. The AVE may be defined for each frame. Furthermore, the control information may be defined in supplemental enhancement information (SEI).

### First Embodiment

Hereinafter, a syntax configuration of the AVE and a decoding method thereof will be described with reference to FIGS. 3 to 5.

FIG. 3 is a diagram illustrating an example of the syntax configuration of the AVE. Here, a syntax name that is different from the syntax name illustrated in FIG. 3 may be used as long as functions of the syntax are the same.

In the syntax configuration of the AVE illustrated in FIG. 3, the Description column indicates how each syntax has been encoded. Furthermore, ue(v) means an unsigned 0-order exponential-Golomb code, and u(n) means an n-bit flag.

Description is merely an example, and encoding methods other than Description in the table, such as u(n), ue(v), and ae(v) may be selected.

The AVE includes a control signal afps_submesh_correction_flag indicating whether to perform sub-mesh boundary correction for each frame.

The AVE includes a control signal afps_border_coding_flag indicating whether to send the boundary information for each frame.

The AVE includes a control signal afps_border_vertex_count_minus1 indicating the number of boundary pairs for each frame.

Here, the boundary pair is a combination of vertices of the same coordinates. Details of the boundary pair will be described later.

The AVE includes a control signal afps_border_vertex_pair_count_minus1[i] indicating the number of vertices constituting the i-th boundary pair for each frame.

The AVE includes a control signal afps_border_submesh_id[i][j] indicating an index of a sub-mesh at the j-th vertex constituting the i-th boundary pair for each frame.

The AVE includes a control signal afps_border_vertex_id[i][j] indicating an index at the j-th vertex constituting the i-th boundary pair for each frame.

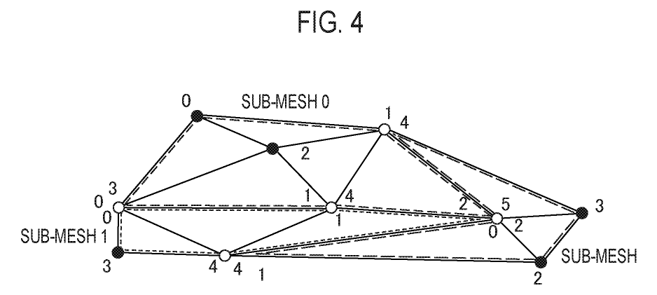

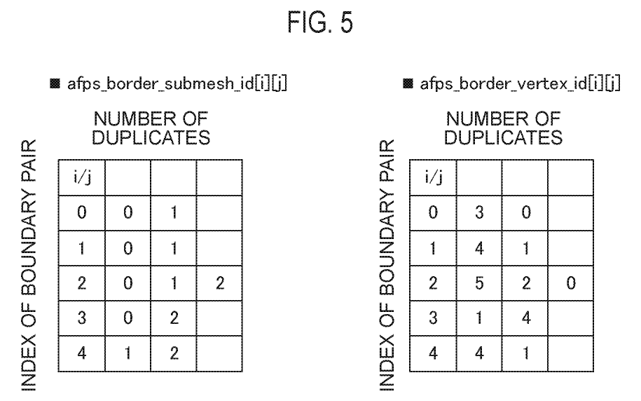

Hereinafter, a method of decoding boundary information will be described using FIGS. 4 and 5.

FIG. 4 illustrates an example of sub-meshes decoded by the base mesh decoding unit 202.

Although displacements are defined for the vertices on the sub-meshes and the subdivided vertices thereof illustrated in FIG. 4, the displacements may differ in a case where indexes of the sub-meshes differ even if the coordinates of the vertices are the same. Therefore, there is a problem that a hole is generated at the sub-mesh boundary when the displacements are added by the mesh decoding unit 204.

In order to solve such a problem, the boundary correction unit 208 corrects the vertices of the decoded mesh output from the mesh decoding unit 204 on the basis of the boundary information.

Here, the boundary information is information related to vertices having the same coordinates regardless of being the vertexes on different sub-meshes at the time of decoding the sub-meshes.

Note that the boundary information is obtained by decoding the above-described atlas bit stream. Also, boundary vertices can be decoded as a collection of boundary pairs.

In the example of FIG. 5, when the index i of a boundary pair is 2, afps_border_submesh_id[2] = [0, 1, 2] and afps_border_vertex_id[2] = [5, 2, 0].

This indicates that the sub-mesh vertex v(0, 5), the sub-mesh vertex v(1,2), and the sub-mesh vertex v(2,0) are the same vertices. Here, v(i, j) indicates the vertex j of the sub-mesh i.

A combination of these same vertices is referred to as a boundary pair. Although the boundary pair in the above example is two, the same applies to all the other boundary pairs.

Any boundary information can be decoded by a procedure similar to that in the above example.

### Second Embodiment

Hereinafter, a syntax configuration of the AVE and a decoding method thereof will be described with reference to FIGS. 4, 6, and 7. Since these are basically the same as those in the first embodiment, only differences from the first embodiment will be described.

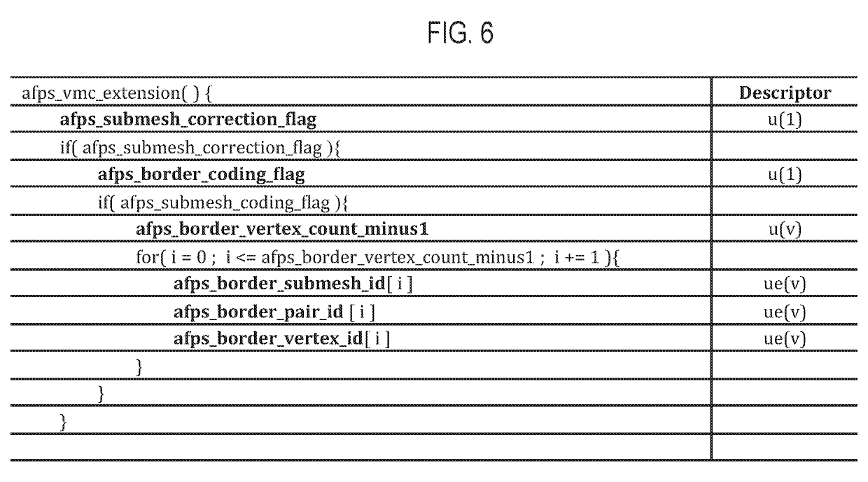

FIG. 6 is a diagram illustrating an example of the syntax configuration of the AVE. Here, a syntax name that is different from the syntax name illustrated in FIG. 4 may be used as long as functions of the syntax are the same.

The AVE includes a control signal afps_border_vertex_count_minus1 indicating the number of boundary vertices for each frame.

The AVE includes a control signal afps_border_submesh_id[i] indicating an index of a sub-mesh at the i-th boundary vertex.

The AVE includes a control signal afps_border_pair_id[i] indicating an index of a boundary pair at the i-th boundary vertex.

The AVE includes a control signal afps_border_vertex_id[i] indicating the i-th boundary vertex index.

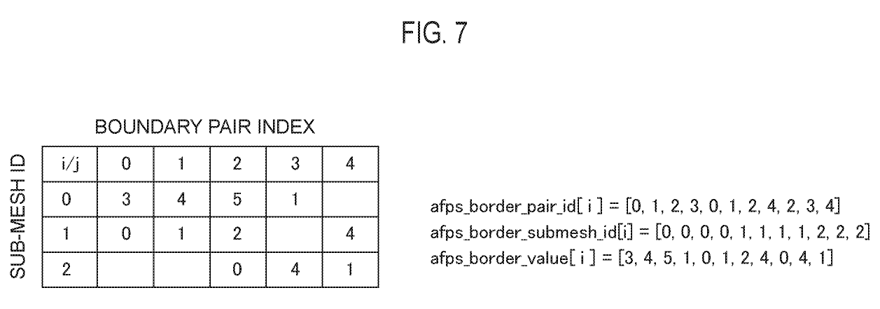

Hereinafter, a method of decoding boundary information will be described using FIGS. 4 and 7.

For example, the index of all the boundary vertices satisfying the index afps_border_pair_id[i] = 2 of the boundary pair is defined as i.

At this time, afps_border_submesh_id[i] and afps_border_vertex_id[i] are [0, 1, 2] and [5, 2, 0], respectively.

This indicates that the sub-mesh vertex v(0, 5), the sub-mesh vertex v(1,2), and the sub-mesh vertex v(2,0) are the same vertices.

Although the boundary pair in the above example is two, the same applies to all the other boundary pairs.

Any boundary information can be decoded by a procedure similar to that in the above example.

### Third Embodiment

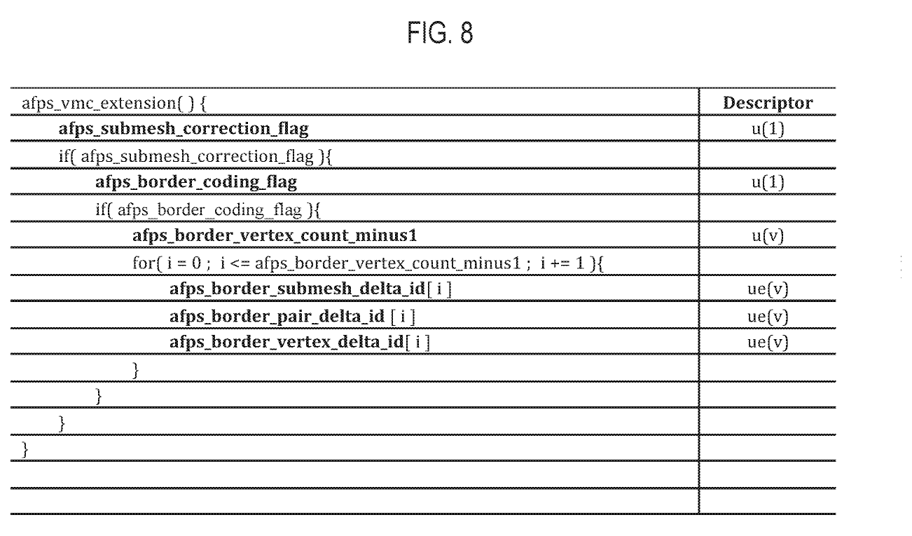

Hereinafter, a syntax configuration of AVE will be described with reference to FIG. 8. Since the syntax configuration is basically the same as that in the second embodiment, only differences from the second embodiment will be described.

The AVE includes a control signal afps_border_submesh_delta_id[i] indicating a difference between an index of a sub-mesh at the (i-1)th boundary vertex and an index of a sub-mesh at the i-th boundary vertex.

The sub-mesh index of the i-th boundary vertex can be decoded by the following procedure.

When i = 0, afps_border_submesh_id[i] = afps_border_submesh_delta_id[i].

When i > 0, afps_border_submesh_id[i] = afps_border_submesh_delta_id[i] + afps_border_submesh_id[i-1].

The AVE includes a control signal afps_border_delta_pair_id[i] indicating a difference between the index at the (i-1)-th boundary vertex and the index of the boundary pair at the i-th boundary vertex.

The index of the boundary pair at the i-th boundary vertex can be decoded by the following procedure.

When i = 0, afps_border_pair_id[i] = afps_border_delta_pair_id[i].

When i > 0, afps_border_pair_id[i] = afps_border_delta_pair_id[i] + afps_border_pair_id[i-1].

The AVE includes a control signal afps_border_vertex_delta_id[i] indicating a difference between the index at the (i-1)-th boundary vertex and the index of the i-th boundary vertex.

The index of the boundary vertex at the i-th boundary vertex can be decoded by the following procedure.

When i = 0, afps_border_vertex_id[i] = afps_border_vertex_delta_id[i].

When i > 0, afps_border_vertex_id[i] = afps_border_vertex_delta_id[i] + afps_border_vertex_id[i-1].

### Base Mesh Decoding Unit 202

The base mesh decoding unit 202 is configured to decode a base mesh bit stream on the basis of control information to generate and output a base mesh.

Here, the base mesh is constituted of one sub-mesh or a plurality of sub-meshes. Each sub-mesh is constituted of a plurality of vertices in a three-dimensional space and sides connecting such a plurality of vertices.

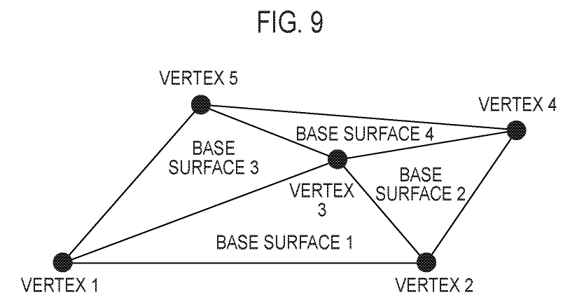

As illustrated in FIG. 9, the base mesh is configured by combining basic faces represented by three vertices.

The base mesh decoding unit 202 may be configured to decode the base mesh bit stream using, for example, Draco described in Non patent Literature 2 (Google Draco, accessed on May 26, 2022 [Online], https://google.github.io/draco).

The base mesh decoding unit 202 may be configured to independently decode the plurality of sub-meshes using Draco.

### Subdivision Unit 203

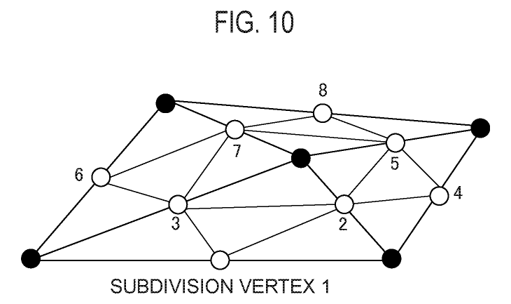

A method of decoding a subdivision mesh in the subdivision unit 203 will be described with reference to FIG. 10.

The subdivision unit 203 is configured to output subdivision meshes, a subdivision vertex normal line, and control information on the basis of the control information and the base mesh.

FIG. 10 is an example of subdivision meshes after subdivision is performed once by the Mid-edge division method. In the Mid-edge division method, the subdivision meshes are generated by dividing sides constituting the meshes at their midpoints.

It is possible to generate finer subdivision meshes by repeating the above-described operation.

The subdivision unit 203 is configured to store between which vertexes each subdivision vertex is located at the time of generating the subdivision vertex and output such information as control information to the boundary correction unit 208.

The subdivision mesh may be configured to be independently decoded for each sub-mesh.

### Displacement Decoding Unit 205

The displacement decoding unit 205 is configured to decode a displacement bit stream to generate and output a displacement.

The displacement may be defined to be calculated independently for each submesh.

### Mesh Decoding Unit 204

The mesh decoding unit 204 is configured to output the decoded mesh based on the input control information, the subdivision mesh, and the displacement.

The mesh decoding unit 204 adds the displacement to the input vertex of the subdivision mesh to decode the decoded mesh.

At this time, the mesh decoding unit 204 may output a plurality of decoded meshes for each submesh based on the displacement corresponding to the submesh and the subdivision mesh.

Furthermore, the mesh decoding unit 204 may be configured to set a coordinate system of the displacement on the basis of a control signal representing a coordinate system of the displacement defined for each submesh, and calculate and output the decoded mesh by adding the displacement to the subdivision vertex on the set coordinate system.

### Boundary Correction Unit 208

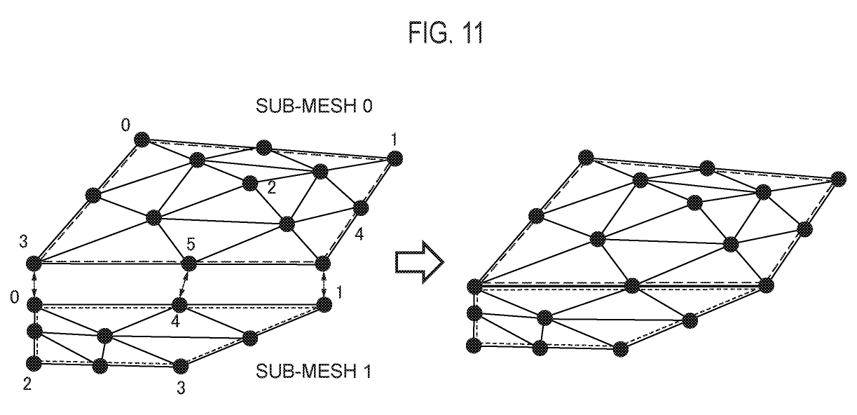

A method in which the boundary correction unit 208 decodes a boundary corrected decoded mesh will be described with reference to FIG. 11.

The boundary correction unit 208 is configured to correct the sub-mesh boundaries for the input decoded mesh and output a boundary corrected decoded mesh.

When the afps_border_signal_coding_flag is “0”, the boundary correction unit 208 uses sub-mesh boundary information of a reference frame as it is as the sub-mesh boundary information.

The boundary correction unit 208 may be configured to skip the boundary correction when the frame to be corrected is not an inter-frame.

The boundary correction unit 208 may be configured such that when neither indexes of sub-meshes nor indexes of vertices included in the boundary information are present, the boundary correction unit 208 skips the boundary correction and outputs the decoded mesh as it is.

Also, the boundary correction unit 208 may be configured such that when indexes of sub-meshes or indexes of vertices included in the boundary information are not present, the boundary correction unit 208 skips correction of only the boundary pairs of these indexes.

FIG. 11 is a diagram schematically illustrating a method of boundary correction. Hereinafter, a procedure of the boundary correction will be described using FIG. 11.

Since the atlas data decoding unit 207 obtains only the boundary pairs of the sub-mesh vertices, it is necessary to obtain the boundary pairs of the subdivision vertices in order to perform correction on the subdivision vertices as well.

Here, a procedure for decoding a boundary pair of subdivision vertices will be described.

First, the boundary correction unit 208 obtains a midpoint of a sub-mesh boundary vertices.

In the example of FIG. 11, the midpoint between the boundary vertex v(0, 3) and the boundary vertex v(0, 4) is v(0, 5).

Next, the boundary correction unit 208 obtains boundary vertex pairs of the boundary vertex v(0, 3) and the boundary vertex v(0, 4). The boundary vertex pairs of the boundary vertex v(0, 3) and the boundary vertex v(0, 4) are the boundary vertex v(1, 0) and the boundary vertex v(1, 1).

Next, the boundary correction unit 208 obtains a midpoint of the boundary vertex v(1, 0) and the boundary vertex v(1, 1). The midpoint is v(1, 4).

Finally, the boundary correction unit 208 regards the boundary vertex v(0, 5) and the boundary vertex v(1, 4) as a boundary vertex pair.

The boundary correction unit 208 can obtain the boundary vertex pair by repeating the above-mentioned procedure when the number of times of subdivision is two or more as well.

The boundary correction unit 208 obtains an average value of vertex coordinates of the vertices constituting each boundary vertex pair and corrects the vertices constituting the boundary vertex pair with the average value.

According to the present embodiment, the boundary information can be efficiently encoded by using the boundary information of the reference frame as it is as the boundary information of the inter-frame.

Furthermore, according to the present embodiment, it is possible to efficiently encode the boundary information using redundancy included in the index of the boundary information.

The mesh encoding device 100 and the mesh decoding device 200 described above may be implemented as programs that cause a computer to execute each function (each step).

Note that, according to the present embodiment, for example, comprehensive improvement in service quality can be realized in moving image communication, and thus, it is possible to contribute to goal 9 “Establish a resilient infrastructure, promote sustainable industrialization, and expand innovation” of the sustainable development goals (SDGs) led by the United Nations.

What is claimed is:

1. A mesh decoding device comprising:
an atlas data decoding unit configured to decode an atlas bit stream to generate and output control information;
a base mesh decoding unit configured to decode the control information and a base mesh bit stream to generate and output a base mesh;
a subdivision unit configured to output a subdivision mesh and a subdivision vertex normal line using the control information and the base mesh as inputs;
a mesh decoding unit configured to generate a decoded mesh using the control information, a displacement, the subdivision mesh, and the subdivision vertex normal line as inputs; and
a boundary correction unit configured to correct a sub-mesh boundary for the decoded mesh and output a boundary corrected decoded mesh.

2. The mesh decoding device according to claim 1, wherein
the atlas data decoding unit decodes a boundary pair by a control signal indicating an index of a sub-mesh at a boundary vertex, a control signal indicating an index of a boundary pair at the boundary vertex, and a control signal indicating an index of the boundary vertex.

3. The mesh decoding device according to claim 1, wherein
the atlas data decoding unit decodes a boundary pair by a control signal indicating a difference of an index of a sub-mesh at a boundary vertex, a control signal indicating a difference of an index of a boundary pair at the boundary vertex, and a control signal indicating a difference of an index of the boundary vertex.

4. A mesh decoding method, comprising:
decoding an atlas bit stream to generate and output control information;
generating and outputting a base mesh using the control information and a base mesh bit stream as inputs;
outputting a subdivision mesh and a subdivision vertex normal line using the control information and the base mesh as inputs;
generating a decoded mesh using the control information, a displacement, the subdivision mesh, and the subdivision vertex normal line as inputs; and
correcting a sub-mesh boundary for the decoded mesh and outputting a boundary corrected decoded mesh.

5. A non-transitory computer-readable medium having stored thereon a program that causes a computer to function as a mesh decoding device, wherein the mesh decoding device includes:
an atlas data decoding unit configured to decode an atlas bit stream to generate and output control information;
a base mesh decoding unit configured to generate and output a base mesh using the control information and a base mesh bit stream as inputs;
a subdivision unit configured to output a subdivision mesh and a subdivision vertex normal line using the control information and the base mesh as inputs;
a mesh decoding unit configured to generate a decoded mesh using the control information, a displacement, the subdivision mesh, and the subdivision vertex normal line as inputs; and
a boundary correction unit configured to correct a sub-mesh boundary for the decoded mesh and output a boundary corrected decoded mesh.
